(19) United States
(12) Patent Application Publication
(10) Pub. No.: US 2014/0251724 A1
(43) Pub. Date: Sep. 11, 2014

(54) FALL-ARREST ANCHORS AND SYSTEMS AND METHODS RELATING THERETO

(71) Applicant: Steven C. Nichols, JR., Woodinville, WA (US)

(72) Inventor: Steven C. Nichols, JR., Woodinville, WA (US)

(21) Appl. No.: 14/172,178

(22) Filed: Feb. 4, 2014

Related U.S. Application Data
(60) Provisional application No. 61/760,572, filed on Feb. 4, 2013.

(51) Int. Cl. A62B 35/00; E04G 21/32

(52) U.S. Cl. CPC A62B 35/0068; E04G 21/3276
USPC 182/3; 248/542; 29/897.34

(57) ABSTRACT

A fall-arrest anchor comprising a single, elongated member having a breaking strength more than 5,000 lb (22.5 kN). The single, elongated member comprises a first anchor portion sized and configured for attachment to a building and a second worker-attachment portion sized and configured for attachment to a worker's lifeline. The first anchor portion is at least about twice as long as the second worker-attachment portion, and the first anchor portion and the second worker-attachment portion are joined at an angle such that subjecting the fall-arrest anchor to a fall-arrest stress load visibly deforms the fall-arrest anchor and visibly changes the angle.

### PRIORITY CLAIM

The present application claims the benefit of copending U.S. Provisional Patent Application No. 61/760,572, filed Feb. 4, 2013, which application is incorporated herein by reference in its entirety.

### BACKGROUND

Builders and workers are both concerned about worker safety when they are working on a part of a building where the workers might fall off the building. Builders and workers also want simple and inexpensive devices to provide such safety. One way to reduce risks to such a worker is to attach the worker by a cable or other lifeline to a “fall-arrest anchor”, which is a device attached to the building that stops, or arrests, the fall of the worker if he or she falls. Such a device must meet US federal and/or ANSI fall-arrest standards in force as of Jan. 31, 2014, such as OSHA 1926:502 (1995), ANSI Z359.1-07 (2007), or ANSI Z359.1-07 (2014). Some examples of such standards can be found, for example, at https://www.osha.gov/pls/oshaweb/owadisp.show_document?p_id=10758&p_table=STANDARDS, or http://webstore.ansi.org/RecordDetail.aspx?sku=ANSI%2FASSE+Z359.1-2007&keyword=inurl:webstore.ansi.org%23inurl:sku%3Dansi&source=google&adgroup=ANSI-Standards&gclid=CMOwpJ2TqwbCFc5hfgodnXgAJA. A fall-arrest anchor has a 5,000 lb (22.5 kN) breaking strength. It is also important to assure that a fall-arrest anchor is not re-used after it has already caught a worker that fell from a structure. This is important because the material of the fall-arrest anchor and/or the material of the structure being built may not “hold up” if a worker has a second fall.

There is a need for improved fall-arrest anchors and for the systems and methods of using them. The present devices, systems and methods, etc., provide these and/or other advantages.

### SUMMARY

The present application is directed to fall-arrest anchors, and related systems and methods, that reduce the risks to workers that are building structures such as houses and office buildings. Such workers can, for example, do high-rise construction, overhead work or roofing installation. The fall-arrest anchors herein provide improved simplicity, economy, and/or ease of ability to insert or attach the fall-arrest anchors to trusses (or other structural elements).

In some aspects the devices, methods and systems herein, provide simple, economical fall-arrest anchors and fall-arrest anchor systems suitable for attachment to a retention element in a structure, such as a truss. The fall-arrest anchors also provide a built-in, easy-to-see “tell-tale” feature that shows when the fall-arrest anchor has already caught a worker that fell (i.e., when the fall-arrest anchor has already been subjected to a fall-arrest stress load).

Thus, in one aspect, the present application provides a fall-arrest anchor having a breaking strength of more than 5,000 lbs (22.5 kN). The fall-arrest anchor comprises a first anchor portion sized and configured for attachment to a building and a second worker-attachment portion sized and configured for attachment to a worker's lifeline.

The first anchor portion and the second worker-attachment portion can be multiple pieces but typically are formed from a single, elongated member.

The first anchor portion can be any desired, adequate length, for example at least about twice as long as the second worker-attachment portion and wherein the first anchor portion and the second worker-attachment portion are joined at a suitable angle to visibly show deformation such as visibly significant bending after being subject to a fall-arrest stress load, for example an angle of more than about 20°, 30°, 45°, 60°, or 90°. The first anchor portion can be at least about two, three or four times longer than the second worker-attachment portion. The fall-arrest anchor can be made of metal such as steel such as 11 gauge A-36 steel. The fall-arrest anchor is compliant with appropriate regulations such as OSHA 1926:502 (1995), ANSI Z359.1-07 (2007), or ANSI 2359.1-07 (2014).

The second worker-attachment portion can comprise a connector hole sized and configured for attachment to a connector element of a worker's lifeline. Any suitable attachment connector for the lifeline can be used such as any class-1 lifeline connector.

The first anchor portion is attachable via any suitable devices to the building under construction, for example via a plurality of nail holes in the first anchor portion. Thus, the first anchor portion can comprise at least 3, 4, 5, or 6 or more nail holes. The nail holes can be disposed non-linearly along a length of the first anchor portion so that nails pounded through the holes will be less likely to split underlying wood beams such as trusses or 2×4s.

The fall-arrest anchor comprises a tell-tale feature 10 that shows when the anchor has been subjected to a fall-arrest stress load, e.g., a load more than 450 or 600 pounds, the angle between the first anchor portion and the second worker-attachment portion visibly flattens out, i.e., approaches 0°. Because of this change in angle, users can easily see if the anchor is still suitable for use or not.

Also provide herein are fall-arrest anchor kits and system comprising a fall-arrest anchor as discussed herein as well as suitable components such as fastening devices such as nails, green vinyl sinkers or screws, and if desired a worker's lifeline. The fall-arrest anchor systems can be attached, typically at the first anchor portion, to a building, as well as the worker's lifeline.

Notably, in some embodiments the fall-arrest anchors herein do not comprise any flashing components.

In further aspects, the discussion herein provides methods of making and of using the fall-arrest anchors, anchor systems and anchor kits herein.

These and other aspects, features and embodiments are set forth within this application, including the following Detailed Description and attached drawings. Unless expressly stated otherwise, all embodiments, aspects, features, etc., can be mixed and matched, combined and permuted in any desired manner.

### BRIEF DESCRIPTION OF THE FIGURES

FIG. 1 depicts perspective views of one embodiment of a fall-arrest anchor before (panel 1a) and after (panel 1b) a fall-arrest stress load has been applied to the anchor.

FIG. 2 depicts a perspective view of one embodiment of a fall-arrest anchor herein attached to a building.

FIG. 3 depicts perspective views of one embodiment of a fall-arrest anchor herein.

FIG. 4 depicts perspective views of a further embodiment of a fall-arrest anchor herein.

FIG. 5 depicts a top plan view of one embodiment of a fall-arrest anchor herein attached to a building and to a worker's lifeline.

FIG. 6 depicts a top plan view of one embodiment of a fall-arrest anchor in the process of being attached to a building and covered with a protective strip.

FIG. 7 depicts a perspective view of one embodiment of a fall-arrest anchor attached to a building via toed-in connectors.

FIG. 8 depicts a top plan view of three fall-arrest anchors attached to a building in a configuration suitable for ease of use by workers working on the building.

### DETAILED DESCRIPTION

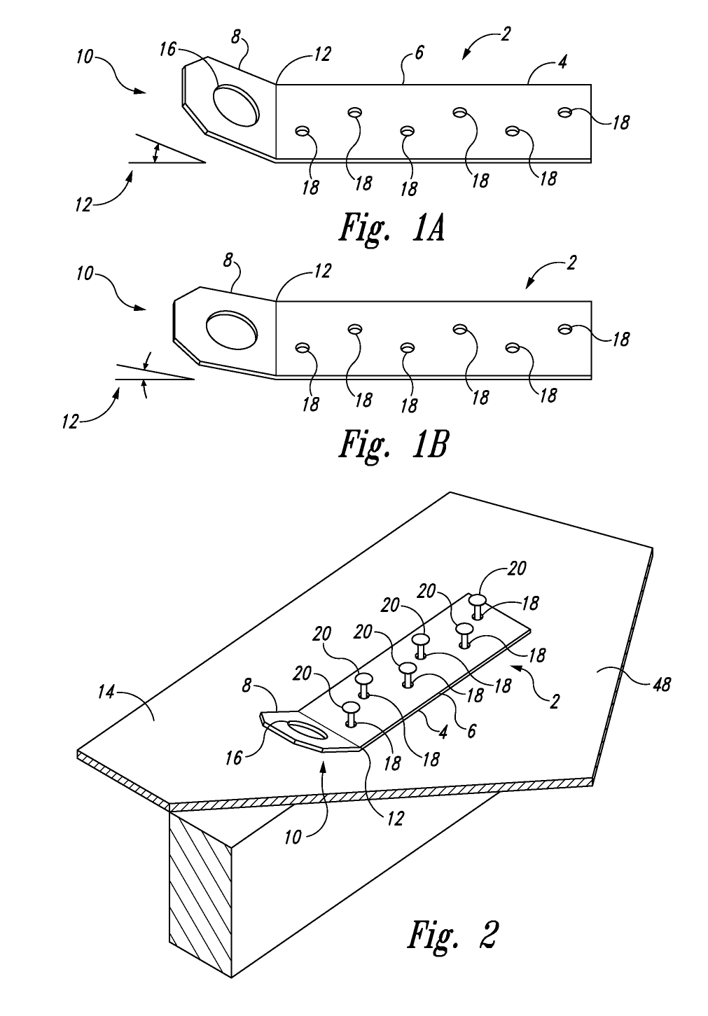

Turning to the figures, FIG. 1 depicts perspective views of an exemplary fall-arrest anchor 2 before (panel 1a) and after (panel 1b) a fall-arrest stress load has been applied. Thus, in FIG. 1, simple, economical fall-arrest anchor 2 comprises a built-in, easy-to-see “tell-tale” feature that shows when the fall-arrest anchor 2 has already caught a worker that fell (i.e., when the fall-arrest anchor 2 has already been subjected to a fall-arrest stress load). Fall-arrest anchor 2 is suitable for attachment to a building or other elevated work site comprising a fall risk, for example at a truss or top chord of a house or office building.

In the embodiment in FIG. 1, fall-arrest anchor 2 has a breaking strength of more than 5,000 lbs (22.5 kN). The fall-arrest anchor 2 comprises a single, elongated member 4 comprising a first anchor portion 6 sized and configured for attachment to a building and a second worker-attachment portion 8 sized and configured for attachment to a worker's lifeline. The first anchor portion 6 can be any desired ratio compared to the second worker-attachment portion 8, for example at least about twice as long as shown.

The first anchor portion 6 and the second worker-attachment portion 8 are joined at an angle 12. The angle can be sharp or comprise a radius. The angle 12 can be at or more than about 30°, 40°, or 45°. The first anchor portion 6 can be at least about two, three or four times longer than the second worker-attachment portion 8. The fall-arrest anchor 2 can be made of metal such as steel such as 11 gauge A-36 steel. The fall-arrest anchor 2 can be compliant with appropriate regulations such as OSHA 1926:502 (1995), ANSI Z359.1-07 (2007), or ANSI Z359.1-07 (2014).

The second worker-attachment portion 8 comprises a hole 16 for lifeline attachment sized and configured for attachment to a worker's lifeline. Any suitable attachment element for the lifeline can be used, it need not be a hole. The first anchor portion 6 is attachable via any suitable devices to the building under construction, for example via a plurality of holes 18 for fasteners in the first anchor portion 6. Thus, the first anchor portion 6 can comprise at least 3, 4, 5, or 6 or more holes 18 for fasteners such as nails, screws or green vinyl sinkers. The holes 18 for fasteners can be disposed non-linearly along a length of the first anchor portion 6 so that nails or screws extended through the holes 18 for fasteners will be less likely to split underlying wood beams such as trusses or 2×4s.

The fall-arrest anchor 2 comprises a tell-tale feature 10 that shows when the anchor has been subjected to a fall-arrest stress load, e.g., a load more than 450 or 600 pounds. As shown by the differences between the fall-arrest anchors 2 and the tell-tale features 10 in panels 1a and 1b of FIG. 1, the angle 12 between the first anchor portion 6 and the second worker-attachment portion 8 visibly flattens out, i.e., approaches 0°, after the fall-arrest anchor 2 is subjected to a fall-arrest stress load, such as a load in excess of 450 or 600 pounds. Because of this change in tell-tale feature 10 and angle 12, users can easily see if the anchor is still suitable for use or not.

Notably, in some embodiments the fall-arrest anchors herein do not comprise any flashing components.

FIG. 2 depicts an embodiment of FIG. 1 of a fall-arrest anchor 2 herein attached an elevated work site 48, namely building 14. In this Figure, fall-arrest anchor 2 is attached via green vinyl sinkers 20 and screws 50.

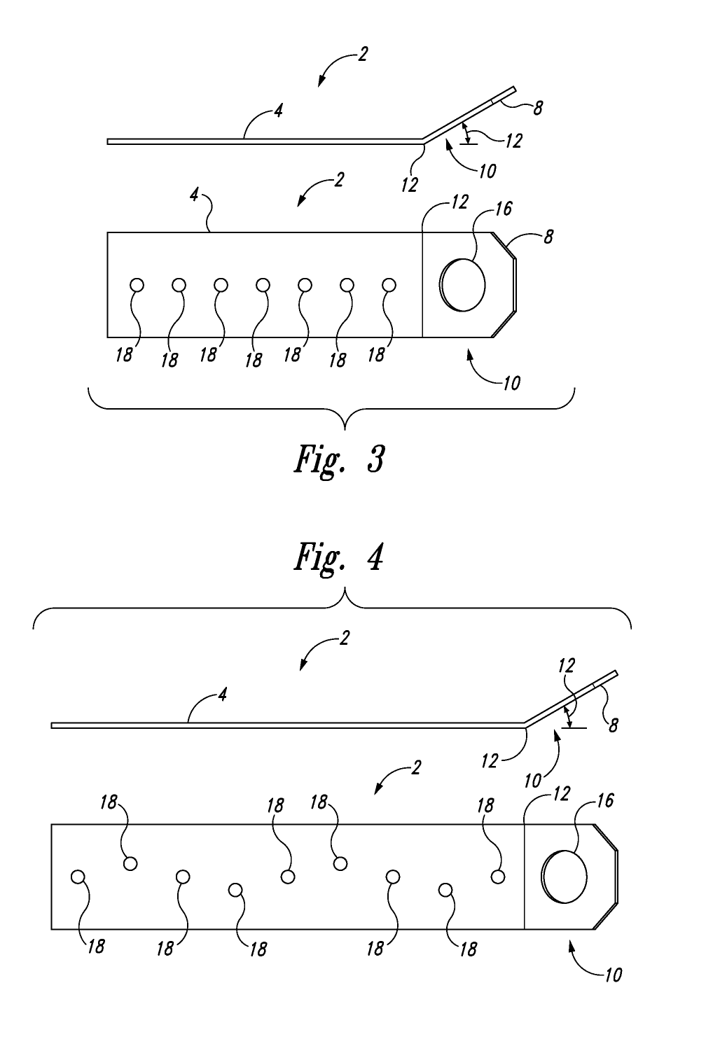

FIGS. 3 and 4 depict different embodiments of fall-arrest anchors 2 herein, wherein the 6 first anchor portions vary in length between the different embodiments.

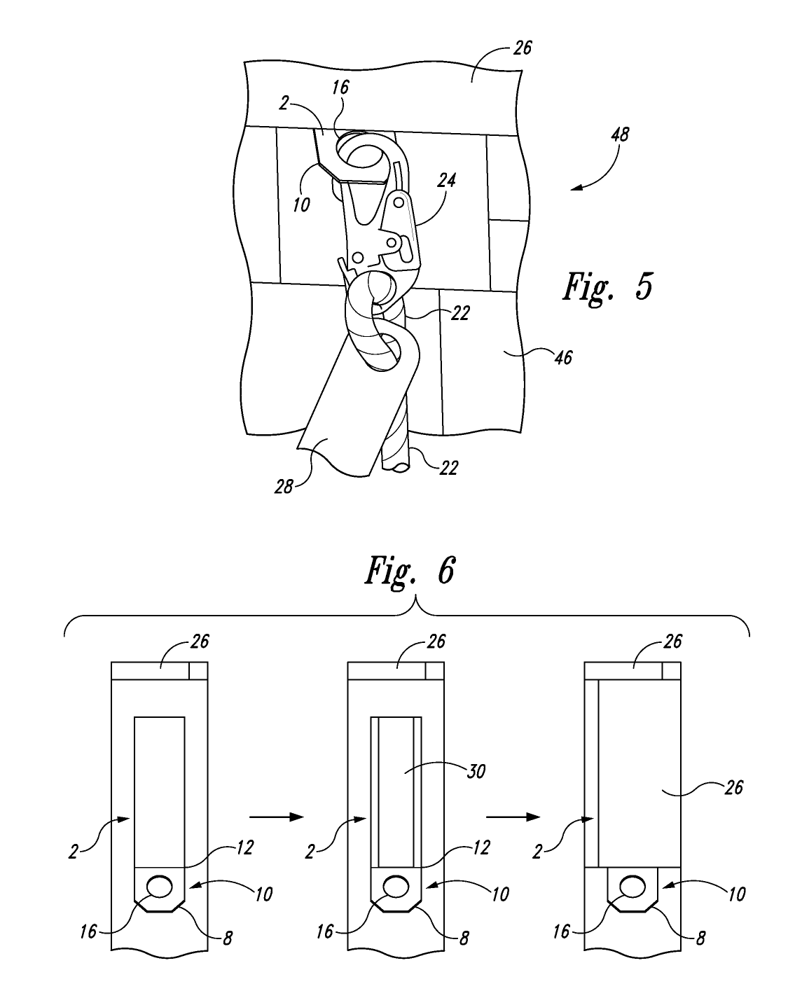

FIG. 5 depicts a fall-arrest anchor 2 attached to a roof 46 made of shingles 26. As can be seen in the Figure, the fall-arrest anchor 2 is disposed partially under the shingles 26 such that only the second worker-attachment portion 8 projects from the roof 46. This can be advantageous because the shingles can add extra strength to the anchorage overall. This also shows that the fall-arrest anchor 2 can be hammered down after use and left in place without disturbing the roof 46. Also shown in FIG. 5 is a label 28 showing desired information such as the identity, purpose and methods of use of the fall-arrest anchor 2, and also a worker's lifeline 22 attached via a carabiner 24 to the lifeline attachment hole 16 of fall-arrest anchor 2.

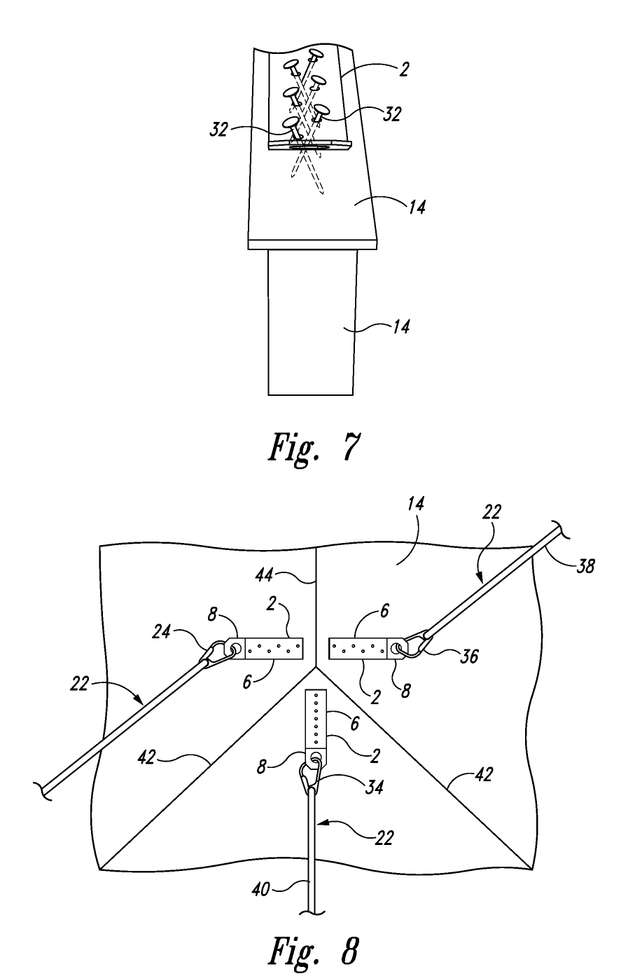

FIG. 6 depicts a fall-arrest anchor 2 in the process of being attached to an elevated work site 48, in this case the roof 46 made of shingles 26 as shown in FIG. 5. The fall-arrest anchor 2 is covered with a protective butyl strip 30 as shown by the progression between the three panels of FIG. 6.

FIG. 7 depicts a fall-arrest anchor 2 attached to a building 14 via toed-in nails 32.

FIG. 8 depicts a top plan view of three fall-arrest anchors 2 attached to a building in a configuration suitable for ease of use by workers working on the building. As can be seen, the three fall-arrest anchors 2 are disposed along the three faces of the roof created by the hip lines 42 and ridge line 44. In addition, the worker's lifelines 22 comprise both a cable 38 and a rope 40, and the lifeline attachment elements include a carabiner 24, a hook 34 and a loop 36.

In further aspects, the discussion herein provides methods of making and of using the fall-arrest anchor 2.

Also provide herein are fall-arrest anchor kits and systems comprising a fall-arrest anchor 2 as discussed herein as well as suitable components such as fastening devices such as nails 32, green vinyl sinkers or screws, and if desired a worker's lifeline 22. The fall-arrest anchor systems comprise the fall-arrest anchor 2 attached to a building 14 and/or a worker's lifeline 22.

All terms used herein are used in accordance with their ordinary meanings unless the context or definition clearly indicates otherwise. Also unless expressly indicated otherwise, in the specification the use of “or” includes “and” and vice-versa. Non-limiting terms are not to be construed as limiting unless expressly stated, or the context clearly indicates, otherwise (for example, “including,” “having,” and “comprising” typically indicate “including without limitation”). Singular forms, including in the claims, such as “a,” “an,” and “the” include the plural reference unless expressly stated, or the context clearly indicates, otherwise.

The scope of the present devices, systems and methods, etc., includes both means plus function and step plus function concepts. However, the claims are not to be interpreted as indicating a “means plus function” relationship unless the word “means” is specifically recited in a claim, and are to be interpreted as indicating a “means plus function” relationship where the word “means” is specifically recited in a claim. Similarly, the claims are not to be interpreted as indicating a “step plus function” relationship unless the word “step” is specifically recited in a claim, and are to be interpreted as indicating a “step plus function” relationship where the word “step” is specifically recited in a claim.

From the foregoing, it will be appreciated that, although specific embodiments have been discussed herein for purposes of illustration, various modifications may be made without deviating from the spirit and scope of the discussion herein. Accordingly, the systems and methods, etc., include such modifications as well as all permutations and combinations of the subject matter set forth herein and are not limited except as by the appended claims or other claim having adequate support in the discussion and figures herein.

1. A fall-arrest anchor comprising a single, elongated member having a breaking strength more than 5,000 lb (22.5 kN), the single, elongated member comprising a first anchor portion sized and configured for attachment to an elevated work site and a second worker-attachment portion sized and configured for attachment to a worker's lifeline, wherein the first anchor portion and the second worker-attachment portion are joined at an angle such that subjecting the fall-arrest anchor to a fall-arrest stress load visibly deforms the fall-arrest anchor and visibly changes the angle.

2. The fall-arrest anchor of claim 1 wherein the first anchor portion is at least about twice as long as the second worker-attachment portion and wherein the angle is more than about 30°.

3. The fall-arrest anchor of claim 1 wherein the first anchor portion is at least about three times longer than the second worker-attachment portion.

4. The fall-arrest anchor of claim 1 wherein the fall-arrest anchor is made of metal.

5. The fall-arrest anchor of claim 1 wherein the fall-arrest anchor is made of steel.

6. The fall-arrest anchor of claim 1 wherein the fall-arrest anchor is compliant with OSHA 1926:502 (1995).

7. The fall-arrest anchor of claim 1 wherein the second worker-attachment portion comprises a hole in the second worker-attachment portion, the hole sized and configured for attachment to a worker's lifeline.

8. The fall-arrest anchor of claim 1 wherein the first anchor portion comprises a plurality of nail holes.

9. The fall-arrest anchor of claim 8 wherein the first anchor portion comprises at least 3 nail holes.

10. The fall-arrest anchor of claim 9 wherein the first anchor portion comprises at least 6 nail holes.

11. The fall-arrest anchor of claim 1 wherein the nail holes are disposed non-linearly along a length of the first anchor portion.

12. The fall-arrest anchor of claim 1 wherein the angle between the first anchor portion and the second worker-attachment portion visibly flattens out when the second worker-attachment portion is subjected to a fall-arrest anchor stress load.

13. The fall-arrest anchor of claim 1 wherein the angle between the first anchor portion and the second worker-attachment portion approaches 0° when the second worker-attachment portion is subjected to a fall-arrest anchor stress load.

14. A fall-arrest anchor kit comprising a fall-arrest anchor of claim 1 and fastening devices sized and configured to attach the first anchor portion to an elevated work site comprising a building.

15. The fall-arrest anchor kit of claim 14 wherein the fastening devices comprise at least one of nails, green vinyl sinkers or screws.

16. The fall-arrest anchor kit of claim 14 wherein the system does not comprise any flashing components.

17. The fall-arrest anchor kit of claim 14 wherein the system further comprises at least one worker's lifeline.

18. A fall-arrest anchor system comprising a fall-arrest anchor of claim 1 attached at the first anchor portion to an elevated work site.

19. The fall-arrest anchor system of claim 18 wherein the fall-arrest anchor is also attached at the second worker-attachment portion to a worker's lifeline.

20. The fall-arrest anchor system of claim 18 wherein the fall-arrest anchor is attached to an elevated work site comprising a building via fastening devices comprising at least one of nails, green vinyl sinkers or screws.

21. The fall-arrest anchor system of claim 1 wherein the assembly does not comprise any flashing components.

22. A method of making a fall-arrest anchor according to claim 1 the method comprising:
a) providing at least one piece of fall-arrest anchor material;
b) forming the material into a fall-arrest anchor sized and configured according to claim 1.

23. The method of claim 22 wherein the method further comprises providing the fall-arrest anchor and fastening devices sized and configured to attach the first anchor portion to an elevated work site to provide a kit according to claim 14.

24. The method of claim 22 wherein the method further comprises attaching the fall-arrest anchor to an elevated work site comprising a building provide a fall-arrest anchor system according to claim 1.

26. (canceled)

27. The method of claim 23 wherein the method further comprises attaching the fall-arrest anchor to a worker's lifeline to provide a fall-arrest anchor system according to claim 1.

28. A method of using a fall-arrest anchor according to claim 1 comprising:
a) providing the fall-arrest anchor according to claim 1, and
b) attaching the fall-arrest anchor to an elevated work site.

29. The method of claim 28 wherein the method further comprises attaching the fall-arrest anchor to a worker's lifeline.
